(19) United States
(12) Patent Application Publication
(10) Pub. No.: US 2024/0396482 A1
(43) Pub. Date: Nov. 28, 2024

(54) METHOD FOR REGULATING AN ELECTRIC MOTOR

(71) Applicant: ZF Friedrichshafen AG, Friedrichshafen (DE)

(72) Inventors: Oussama Jabloun, Friedrichshafen (DE); Franz Prenner, Friedrichshafen (DE)

(73) Assignee: ZF Friedrichshafen AG, Friedrichshafen (DE)

(21) Appl. No.: 18/672,639

(22) Filed: May 23, 2024

(30) Foreign Application Priority Data
May 26, 2023 (DE) 10 2023 204 923.6

(51) Int. Cl. H02P 21/20

(52) U.S. Cl. CPC H02P 21/20

(57) ABSTRACT

A method for downward-regulating an electric motor (15) comprises a weighting factor-determination process (P2) in which weighting factor values (4) are determined continuously, an integration process (P3) in which the weighting factor values (4) are added so that an integration value (5) is formed, and a downward-regulation process (P4) in which the electric motor (15) is regulated if the integration value (5) is above a threshold value (6).

### RELATED APPLICATIONS

This application claims the benefit of and right of priority under 35 U.S.C. § 119 to German Patent Application no. 10 2023 204 923.6, filed on 26 May 2023, the contents of which are incorporated herein by reference in its entirety.

### FIELD OF THE DISCLOSURE

The invention relates to a method for regulating an electric motor, according to the present disclosure. The invention also relates to a system, a vehicle, a computer program, and a computer-readable medium.

### BACKGROUND

Electric vehicles typically comprise one or more electric motors with the help of which the electric vehicle is driven. During a journey such electric motors are loaded to different extents. In particular, at different times different torques are called for from the electric motors, particularly as the driver actuates the accelerator pedal to a greater or lesser extent.

With electric motors there is always a possibility of overloading, for example if the electric motor is called upon to deliver torques that are too large for too long a time, which for example can result in overheating of the electric motors. Consequently, it is typically necessary when operating electric vehicles to downward-regulate electric motors that are overloaded so that they can deliver only certain reduced torques, at least for a certain time, in particular until they have recovered from previous severe loading.

However, the downward-regulation of electric motors in electric vehicles is not simple. In particular the downward-regulation should take place neither too early nor too late. Known systems for the downward-regulation of electric motors also have the disadvantage that at times users of the vehicle regard them as unpleasant, for example because the downward-regulation takes place too abruptly or too harshly.

### SUMMARY

The purpose of the present invention is to overcome or at least mitigate the disadvantages of the prior art.

This objective is achieved by a method for downward-regulating an electric motor, wherein the method has the following steps: a weighting factor-determination process in which weighting factor values are determined continuously, an integration process in which the weighting factor values are added so that an integration value is formed, and a downward-regulation process in which the electric motor is regulated when the integration value is above a threshold value.

The term “weighting factor value” is understood to mean a value which indicates how severely an electric motor is loaded at a given point in time. By virtue of the continuous calculation of weighting factor values, which are typically not constant during the course of the method, but which vary continually during the operation of the electric motor, and by adding these weighting factor values in the integration process, the result is obtained that the integration value, so to speak, corresponds to a “recollection” of the loading of the electric motor. In this “recollection” variously severe loads are “stored” by this addition, wherein severe loads are typically more strongly weighted than less severe loads. In typical embodiments the integration value changes continuously and can therefore be below the threshold value at certain times, can then be above the threshold value for a certain time, and can then fall again to below the threshold value, particularly when after exceeding the threshold value a phase of less severe loading of the electric motor follows, during which for example negative weighting factor values are determined, which then successively lower the integration value again.

In typical embodiments, during the weighting factor-determination process a current motor torque of the electric motor is compared with a lasting torque value, and a positive weighting factor is determined if the current motor torque is higher than the lasting torque value, whereas a negative weighting factor is determined if the current motor torque is lower than the lasting torque value. In typical embodiments the lasting torque value is a torque that the electric motor can deliver for approximately 30 minutes without being overloaded. In this description the term “approximately” is typically to be understood as meaning that it describes a tolerance of at most ±20%, preferably ±15% and advantageously at most ±10%. By determining the weighting factor value in that way, loads above the lasting torque value result in an increase of the integration value and so bring the electric motor closer to downward-regulation, while in contrast loads lower than the lasting torque value reduce the integration value, whereby the electric motor moves progressively farther from a downward-regulation.

In typical embodiments, within the framework of the weighting factor-determination process the weighting factor is determined with reference to a weighting factor curve that describes the weighting factor as a function of the current motor torque, such that the weighting factor curve for a current motor torque that corresponds to the lasting torque value typically has the value “0”, and/or such that the weighting factor curve for a current motor torque, which corresponds to a maximum torque value, typically has a maximum value such that the maximum torque value is larger than the lasting torque value, and/or wherein the slope of the weighting factor curve in the direction of the maximum torque value typically rises continuously, at least when a torque value of increasing gradient is exceeded. In typical embodiments the maximum torque value is a torque which the electric motor can deliver for approximately 30 seconds without being overloaded. In advantageous embodiments the weighting factor curve is specified not by a mathematical function, but by a look-up table. Such a look-up table is typically established by a development engineer for the configuration of an electric vehicle or a control unit for an electric vehicle or the like. In this case the maximum value is a highest value that the weighting factor can adopt during the course of the method. In other words, in the context of the weighting factor-determination process this maximum value is accepted as the weighting factor value when, and only when the current motor torque of the electric motor is at the maximum torque value. For all current motor torques lower than the maximum torque value, the weighting factor-determination process produces corresponding weighting factor values which are in each case lower than the maximum value. For that reason, smaller weighting factor values are then added in the integration step for all such torques. Accordingly, the result is that not all loads above the lasting torque have as much impact. The fact that in addition, in typical embodiments, the slope of the weighting factor is not constant but increases toward the maximum torque value, has the advantage that current motor torques have a greater impact, the closer they are to the maximum torque value. The inventors have established by tests that such a weighting factor curve, whose slope increases in the direction of the maximum torque value, is advantageous because in that way a reliable and pleasant downward-regulation can be made possible, at least in some cases. The expression “at least when a steepening torque value is exceeded” should be understood to mean that in an area between the lasting torque value and the steepening torque value the curve can rise at first linearly, i.e., with a constant slope, and can increase its slope progressively only after reaching the steepening slope torque value.

In typical embodiments, the method includes a torque value determination process, in which the lasting torque value and/or the maximum torque value is/are determined continuously as a function of a current motor rotation speed. In typical embodiments the continuous determination of the lasting torque value and/or the maximum torque value is/are achieved with the help of curves that show, respectively, the lasting torque value and/or the maximum torque value as a function of a current motor rotation speed. These curves are typically described by look-up tables and not by mathematical functions. In typical embodiments each of the two curves has first (i.e., between a rotation speed value “0” and a higher rotation speed value, which is known as the reduction threshold) a constant value, i.e., it extends horizontally. After that each curve falls, typically in a non-linear manner, in particular at first very steeply and then continually more flatly. In other words, the lasting torque values and/or the maximum torque values are typically higher for lower motor rotation speeds than for higher motor rotation speeds.

In typical embodiments, in the context of the downward-regulation process, in cases when the integration value has exceeded the threshold value the current motor torque of the electric motor is regulated, wherein a degree of downward-regulation is determined as a function of the integration value, wherein the degree of downward-regulation is determined as a downward-regulation percentage, wherein the downward-regulation percentage is 100% for the threshold value, wherein for further increasing integration values the downward-regulation percentage typically decreases continually, wherein the downward-regulation percentage for a maximum integration value is 0%, and wherein between the threshold value and the maximum integration value the downward-regulation percentage preferably falls in a linear manner. In typical embodiments, the maximum integration value is approximately twice as high as the threshold value. A downward-regulation process designed in that way has the advantage that from a time-point when the integration value exceeds a threshold value, downward-regulation is carried out and so the electric motor is protected against overload, and the downward-regulation does not take place abruptly but, depending on how large the integration value actually is, it becomes progressively more severe. In that way, despite the downward-regulation an acceptable level of driving comfort in an electric vehicle can be maintained. However, other types of downward-regulation too are possible, for example step-wise downward-regulation or non-linear downward-regulation, or even abrupt downward-regulation.

In typical embodiments, during the method, preferably during the downward-regulation process, a torque limit value is calculated continuously for the electric motor, the said torque limit value being calculated from the following formula:

$${M}_{Grenz} = {M}_{Dauer} + k * ( {M}_{max} - {M}_{Dauer} )$$

in which M_{Grenz} is the torque limit value. M_{Dauer} is the lasting torque value. Mₘₐₓ is the maximum torque value and k is the downward-regulation percentage.

In typical embodiments the electric motor must not at any time deliver a torque that exceeds the torque limit value. This prevents overloading of the electric motor.

The objective is further achieved by a system comprising means for at least partially carrying out a method in accordance with at least one of the above-described embodiments.

In advantageous embodiments the system is suitable for at least partially carrying out and/or coordinating and/or controlling a method in accordance with at least one of the above-described embodiments. For that purpose, the system advantageously comprises suitable components, for example a weighting factor-determining component and/or a torque-determining component and/or a motor rotation speed-determining component and/or a torque limit value-calculating component which is suitable for calculating the torque limit value during an operation of the electric motor, from the above equation.

In advantageous embodiments the system comprises a control component which is suitable for controlling the method.

Advantageously, in the system at least some of the aforesaid components are implemented by means of computer program codes. In advantageous embodiments the system, in particular at least some of the aforesaid components, are at least partially part of a vehicle control system and/or a Cloud. In typical embodiments the system comprises a digital control unit and/or a display and/or means for data input and/or means for data output.

In an embodiment of the invention a vehicle is suitable for carrying out a method according to at least one of the aforesaid embodiments, and/or contains a system according to one of the aforesaid embodiments. For that purpose, the vehicle typically contains means for carrying out a method according to at least one of the aforesaid embodiments.

In an embodiment of the invention a computer program contains commands which, when the computer program is run on a computer, enables it to carry out one of the aforesaid methods. The computer program can also be called a computer program product.

In an embodiment of the invention a computer-readable medium contains computer program codes for carrying out one of the aforesaid methods. The term “computer-readable medium” covers in particular but not exclusively hard disks and/or servers and/or memory sticks and/or flash memories and/or DVDs and/or Bluerays and/or CDs. In addition, the term “computer-readable medium” includes a data stream as is produced, for example, when a computer program and/or a computer program product is downloaded from the internet.

### BRIEF DESCRIPTION OF THE DRAWINGS

Below, the invention is explained briefly with reference to drawings, which show:

FIG. 1: A schematic representation of a possible embodiment of a method according to the invention,

FIG. 2: A possible curve that pictures the lasting torque value as a function of the current motor rotation speed,

FIG. 3: A possible curve that pictures the maximum torque value as a function of the current motor rotation speed,

FIG. 4: A first possible embodiment of a weighting factor curve,

FIG. 5: A second possible embodiment of a weighting factor curve,

FIG. 6: A possible embodiment of a downward-regulation percentage curve, and

FIG. 7: A schematic representation of a vehicle according to the invention, with a system according to the invention in a possible embodiment.

### DETAILED DESCRIPTION

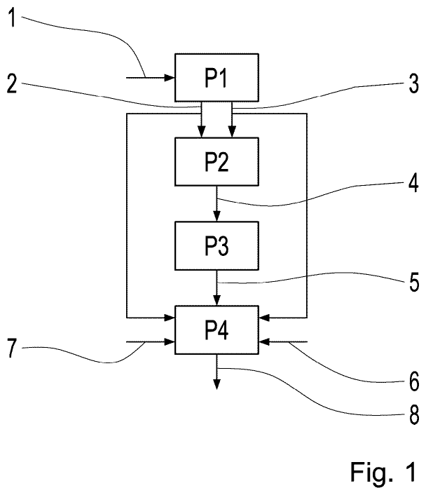

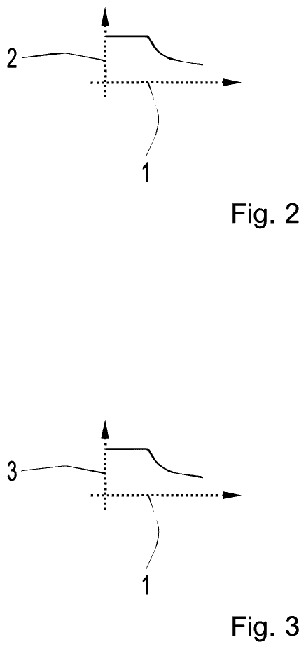

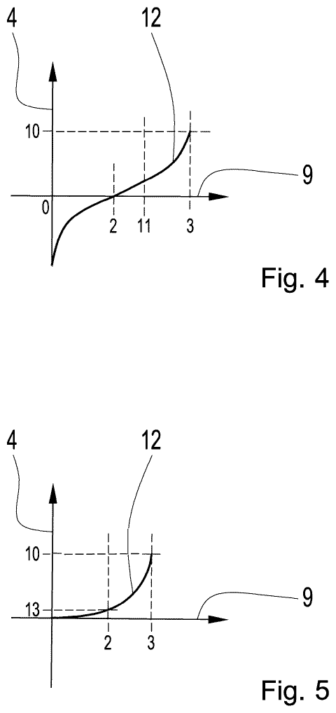

FIG. 1 shows a schematic representation of a possible embodiment of a method according to the invention. In particular, FIG. 1 shows a flow chart with a torque value-determining process P1, a weighting factor-determining process P2, an integration process P3 and a downward-regulation process P4. During the operation of an electric vehicle the method typically runs continuously, i.e., for example in an endless loop. In this case it is also possible for at least some of the processes P1, P2, P3, P4 shown in FIG. 1 to take place in parallel and/or with overlap, at least some of the time. The current motor rotation speed 1 is continuously fed to the torque value-determination process P1. This current motor rotation speed 1 is represented in FIG. 1 by a thick arrow. The other thick arrows in FIG. 1 also represent data flows. On the basis of the current motor rotation speed 1 the torque value-determining process P1 continually determines a lasting torque value 2 and a maximum torque value 3. These torque values 2, 3 are typically determined in the torque value-determining process P1 with the help of previously established curves, which picture the torque values 2, 3 as a function of the motor rotation speed. Examples of such curves are shown in FIGS. 2 and 3, which are discussed below. The lasting torque value 2 and the maximum torque value 3 are each fed into both the weighting factor-determining process P2 and the downward-regulation process P4. In the weighting factor-determining process P2, on the basis of the lasting torque value 2 and the maximum torque value 3 a weighting factor 4 is determined. In the weighting factor-determining process P2 this determination of the weighting factor value 4 takes place with the help of a weighting factor curve, which will be discussed in detail with reference to FIGS. 4 and 5. The weighting factor value 4 is then sent to the integration process P3. In the integration process P3 the weighting factor value 4 is added to an integration value 5. It can be seen that since the method shown in FIG. 1 takes place continuously during the course of the method, weighting factor values 4 are being continuously provided to the integration process P3, which are added to the integration value 5 so that during the process the integration value 5 increases (or decreases if there are negative weighting factors 4). Thus, the integration value 5 shown in FIG. 1 is likewise a continually varying value. This integration value 5 is then sent to the downward-regulation process P4. In addition, a threshold value 6 and a maximum integration value 7 are sent to the downward-regulation process P4. The threshold value 6 is a threshold value with which the integration value 5 is continuously compared. If the integration value 5 exceeds the threshold value 6, a downward-regulation of the mechanical power or the rotation speed of the electric motor is initiated. The maximum integration value 7 is a value that the integration value cannot exceed. If the integration value 5 reaches this maximum integration value 7, then addition to the integration value 5 is stopped and the downward-regulation process P4 regulates the electric motor to the lasting torque value 2. In other words, the electric motor can then no longer deliver a torque greater than the lasting torque. Only an addition of negative weighting factor values 4 is possible in that case, so that the integration value 5 can only be reduced, but not increased. When in that case the integration value 5 decreases, then little by little a torque is again possible which rises above the lasting torque value 2. The lasting torque value 2 and the maximum torque value 3 are sent to the downward-regulation process 4 because the downward-regulation process 4 continually calculates the torque limit value 8 as a function of those two torque values 2, 3, which limit the electric motor must at no time exceed. In the example embodiment shown in FIG. 1 the torque limit value 8 is determined in accordance with the equation below:

$${M}_{Grenz} = {M}_{Dauer} + k * ( {M}_{max} - {M}_{Dauer} )$$

in which M_{Grenz} is the torque limit value 8. M_{Dauer} is the lasting torque 2, Mₘₐₓ is the maximum torque value 3 and k is the downward-regulation percentage.

The torque limit value 8 is relayed continuously by the downward-regulation process P4 so that the vehicle components that control the electric motor are notified at all times what maximum torque the electric motor may deliver.

FIG. 2 shows a possible curve which pictures the lasting torque value 2 as a function of the current motor rotation speed 1. As can be seen in FIG. 2, in a low rotation speed range the lasting torque value 2 is at first constant, but from a particular value the lasting torque value 2 then falls, at first relatively steeply and then progressively less steeply.

FIG. 3 shows a possible curve which pictures the maximum torque value 3 as a function of the current motor rotation speed 1. As regards FIG. 3 it can again be said that in a low rotation speed range the maximum torque value 3 remains constant at a particular value, after which it falls in a manner comparable to the curve shown in FIG. 2.

FIG. 4 sows a weighting factor curve 12 in a first possible embodiment. The weighting factor curve 12 describes the weighting factor value 4 as a function of the current motor torque 9. With the help of this curve, in the context of the method the weighting factor-determination process P2 continuously determines the weighting factor value 4. The curve 12 shown in FIG. 4 has a weighting factor value 4 of “0” for the lasting torque value 2. For current motor torques 9 lower than the lasting torque value 2 the weighting factor values 4 are negative. For current motor torques 9 higher than the lasting torque value 2 the curve 12 shows that the weighting factor values 4 are positive. At a current motor torque 9 that corresponds to the maximum torque value 3, the weighting factor value 4 has a maximum value of 10, which can also be called the maximum weighting factor value 10. Between the lasting torque value 2 and the maximum torque value 3 the weighting factor curve 12 rises continuously. In particular, in an area between the lasting torque value 2 and a slope-increase torque value 11 the weighting factor curve 12 has a constant slope and in particular rises linearly. Between the said slope-increase torque value 11 and the maximum torque value 3 the slope of the weighting factor curve 12 increases progressively so that at the end of the weighting factor curve 12, namely when the maximum torque value 3 is reached, the slope of the weighting factor curve 12 is at its maximum, at least for the positive region of the weighting factor curve 12.

FIG. 5 now shows a second possible embodiment of a weighting factor curve 12. In FIG. 5 the weighting factor curve 12 again shows the weighting factor 4 as a function of the current motor torque 9. In FIG. 5, however, the shape of the weighting factor curve 12 is different from that of the weighting factor curve 12 in FIG. 4. In particular the weighting factor curve 12 shown in FIG. 5 has no negative values. Rather, with the weighting factor curve 12 of FIG. 5, at the lasting torque value 2 the value of the lasting-torque weighting factor 13 is positive. For current torques 9 which are lower than the lasting torque value 2, there are also positive values. At the maximum torque value 3 the weighting factor value 4 has a value equal to that of the maximum weighting factor value 10. The example shown in FIG. 5 has the special feature that in this case the integration value (not shown in FIG. 5) cannot be fed with negative weighting factor values 4, since in this example the weighting factor value 4 is always positive. In such a case, typically the integration value is reduced or eliminated in some other way in order to operate the electric motor more sparingly, for example on the basis of a temperature measurement at the electric motor.

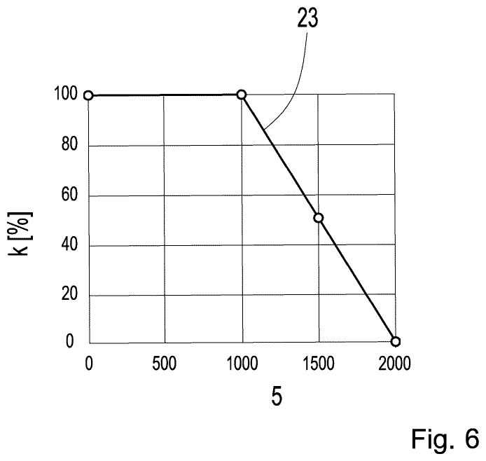

FIG. 6 shows a possible embodiment of a downward-regulation percentage curve 23. The downward-regulation percentage curve 23 describes the variation of the downward-regulation percentage k as a function of the integration value 5. For an integration value 5 between “0” and “1000” the downward-regulation percentage curve 23 remains constant at a downward-regulation percentage of 100%. If the integration value 5 is larger than “1000” the downward-regulation percentage k decreases: in the example embodiment shown in FIG. 6 the downward-regulation percentage k falls linearly between the integration values “1000” and “2000” from 100% to 0%. Considering now the equation often already mentioned earlier:

$${M}_{Grenz} = {M}_{Dauer} + k * ( {M}_{max} - {M}_{Dauer} )$$

for calculating the torque limit value 8, then it emerges that with the downward-regulation percentage curve 23 shown in FIG. 6, at a torque where the integration value 5 reaches “1000” as a threshold value the torque limit value 8 corresponds to the maximum torque value 3, because until then the downward-regulation percentage k had remained at the value “100%”. Thus, so long as the integration value 5 has not yet reached the value “1000” (which corresponds to the previously introduced threshold value 6), the electric motor can be operated at up to its maximum torque value 3. When the integration value 5 has reached the value “2000” and the downward-regulation percentage correspondingly has the value “0”, the above equation shows that the torque limit value 8 then corresponds exactly to the lasting torque value 2. The electric motor must then be operated at most up to its lasting torque value 2. When the integration value 5 is between the value “1000” (i.e. the threshold value 6) and the value “2000” (i.e. the maximum integration value 7), this corresponds to the torque limit value 8 which is the maximum that the electric motor should deliver according to the above equation, so that the downward-regulation percentage k is then naturally also determined in accordance with the downward-regulation percentage curve 23 (and is correspondingly in the linearly decreasing portion of the downward-regulation percentage curve 23).

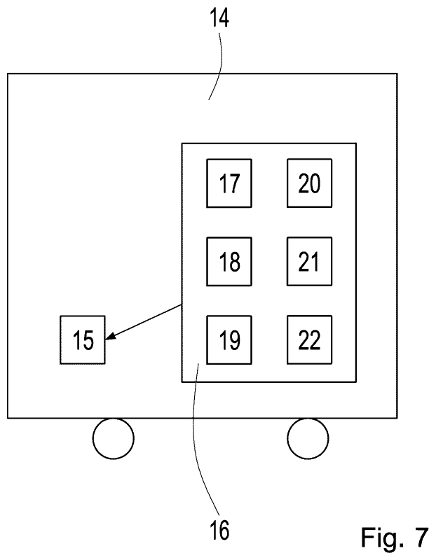

FIG. 7 now shows a schematic representation of a possible embodiment of a vehicle 14 according to the invention with a system 16 according to the invention and an electric motor 15. The system 16, which is suitable for carrying out a method according to the invention for downward-regulating the electric motor 15, is suitable for acting upon the electric motor 15 as indicated by the thick arrow in FIG. 6. The system 16 comprises the components 17, 18, 19, 20, 21 and 22, which are suitable for carrying our processes and/or part-aspects of the method, namely a weighting factor-determining component 17, an integration component 18, a downward-regulation component 19, a torque-value determination component 20, a motor rotation speed determination component 21 and a torque limit calculation component 22.

The invention is not limited to the example embodiments described. Its protective scope is defined by the claims.

In principle, all the methods described in the description or in the claims can be carried out by devices that comprise means for carrying out the respective process steps of this method.

### INDEXES

1 Current motor rotation speed
2 Lasting torque value
3 Maximum torque value
4 Weighting factor value 4
5 Integration value
6 Threshold value
7 Maximum integration value
8 Torque limit value
9 Current motor torque
10 Maximum value/maximum weighting factor value
11 Slope-increase torque value
12 Weighting factor curve
13 Lasting torque weighting factor value
14 Vehicle
15 Electric motor
16 System
17 Weighting factor-determination component
18 Integration component
19 Downward-regulation component
20 Torque value determination component
21 Motor rotation speed determination component
22 Torque limit calculation component
k Downward-regulation percentage
P1 Torque value determination process
P2 Weighting factor determination process
P3 Integration process
P4 Downward-regulation process

1-10. (canceled)

11. A method for downward-regulating an electric motor (15), comprising:
determining weighting factor values (4) on a continuous basis;
adding the weighting factor values (4) to arrive at an integration value (5);
determining that the integration value (5) is above a threshold value; and
regulating the electric motor (15).

12. The method according to claim 11, wherein determining the weighting factor values comprises:
comparing a current motor torque (9) of the electric motor with a lasting torque value (2);
determining that the current motor torque (9) is higher than the lasting torque value (2); and
determining a positive weighting factor value.

13. The method according to claim 12, wherein
determining the weighting factor values takes into account a weighting factor curve (12) which describes the weighting factor value (4) as a function of the current motor torque (9), wherein the weighting factor curve (12) for a current motor torque (9) that corresponds to the lasting torque value (2) has a value of “0”; and/or
wherein the weighting factor curve (12) for a current motor torque (9) that corresponds to a maximum torque value (3) has a maximum value (10) that is larger than the lasting torque value (2); and/or
wherein a slope of the weighting factor curve (12) in the direction of the maximum torque value (3) increases continuously at least when a slope-increase torque value (11) is exceeded.

14. The method according to claim 11, wherein determining the weighting factor values comprises:
comparing a current motor torque (9) of the electric motor with a lasting torque value (2);
determining that the current motor torque (9) is lower than the lasting torque value (2); and
determining a negative weighting factor value.

15. The method according to claim 14, wherein
determining the weighting factor values takes into account a weighting factor curve (12) which describes the weighting factor value (4) as a function of the current motor torque (9), wherein the weighting factor curve (12) for a current motor torque (9) that corresponds to the lasting torque value (2) has a value of “0”; and/or
wherein the weighting factor curve (12) for a current motor torque (9) that corresponds to a maximum torque value (3) has a maximum value (10) that is larger than the lasting torque value (2); and/or
wherein a slope of the weighting factor curve (12) in the direction of the maximum torque value (3) increases continuously at least when a slope-increase torque value (11) is exceeded.

16. The method according to claim 12, comprising:
determining the lasting torque value (2) and/or the maximum torque value (3) on a continuous basis as a function of a current motor rotation speed (1).

17. The method according to claim 11 in the downward-regulation process (P4), in cases when
determining that the integration value (5) has exceeded the threshold value (6); and
regulating the current motor torque (9) of the electric motor (15) in such manner that a degree of downward-regulation is determined as a function of the integration value (5);
wherein the degree of downward-regulation is determined by a downward-regulation percentage (k), wherein the downward-regulation percentage (k) is 100% for the threshold value (6), wherein the downward-regulation percentage (k) decreases for further growing integration values (5), wherein the downward-regulation percentage (k) is 0% for a maximum integration value (7), and wherein between the threshold value (6) and the maximum integration value (7) the downward-regulation percentage (k) decreases linearly.

18. The method according to claim 17, comprising:
determining a torque limit value (8) for the electric motor (15) on a continuous basis, wherein the torque limit value (8) is calculated in accordance with the following equation:
$${M}_{Grenz} = {M}_{Dauer} + k * ( {M}_{max} - {M}_{Dauer} )$$
in which M_{Grenz} is the torque limit value (8), M_{Dauer} is the lasting torque value (2), Mₘₐₓ is the maximum torque value (3), and k is the downward-regulation percentage (k).

19. The method according to claim 18, wherein determining the torque limit value is performed during regulating the current motor torque.

20. A system (16) comprising means for at least partially carrying out a method according to claim 11.

21. A vehicle (14) configured for carrying out a method according to claim 11.

22. Computer program product containing executable code, wherein when executed by a computer, carries out the method of claim 11.
